(19) United States
(12) Patent Application Publication
(10) Pub. No.: US 2024/0001898 A1
(43) Pub. Date: Jan. 4, 2024

(54) FILTER FOR A BRAKE FLUID RESERVOIR

(71) Applicant: ZF Active Safety US Inc., Livonia, MI (US)

(72) Inventor: Mikel Esandi, Farmington Hills, MI (US)

(21) Appl. No.: 17/852,889

(22) Filed: Jun. 29, 2022

(51) Int. Cl. B60T 11/26; B60T 17/06; B01D 29/03; B01D 29/56

(52) U.S. Cl. CPC B60T 11/26; B60T 17/06; B01D 29/036; B01D 29/56

(57) ABSTRACT

A filter for a brake fluid reservoir includes a side wall. A flange extends from the side wall at a first end of the side wall. A flange aperture extends through the flange. An end wall is at a second end of the side wall. An end aperture extends through the end wall. A first filter mesh covers the flange aperture for preventing contaminants from passing through the flange aperture. A second filter mesh covers the end aperture for preventing contaminants from passing through the end aperture.

### FIELD OF THE INVENTION

The present invention relates to a filter for a brake fluid reservoir, as well as to a brake fluid reservoir for a vehicle brake system.

### BACKGROUND OF THE INVENTION

Brake fluid reservoirs for vehicle brake systems are known. FIGS. 1-3 schematically depict such a brake fluid reservoir 102 for a vehicle brake system 104. The brake fluid reservoir 102 includes a housing 130 that defines a fluid chamber 132 and has a fluid inlet port 134 through which brake fluid F is supplied into the fluid chamber 132. A filter 100 is inserted into the fluid inlet port 134 and supported on an inner shoulder 136 of the fluid inlet port via a flange 112. The filter 100 includes at least one aperture 126 on an end wall 122 and a plurality of apertures 144 on a side wall 106 for the passage of brake fluid F. Each of the apertures 126, 144 is covered in a filter mesh 128, 146.

The fluid chamber 132 may be filled via vacuum filling. Vacuum filling often requires an automatic filling unit (not shown) having an adapter part which forms a seal with the fluid inlet port 134, and one or more tubes that extend into the fluid inlet port for providing brake fluid F, for vacuuming/siphoning out a predetermined amount of brake fluid, and for providing air for pressure-balancing. FIG. 1 schematically depicts the brake fluid reservoir 102 after having been filled by the automatic filling unit. As can be seen, the automatic filling unit fills the brake fluid reservoir 102 past a maximum filling level ML of the fluid chamber 132. In FIG. 2, the automatic filling unit then siphons out excess brake fluid F to reduce the brake fluid level in the fluid reservoir 102 to the maximum filling level ML.

As can be seen in FIG. 2, during the siphoning, the surface tension of the brake fluid F against the side wall filter meshes 146 may create a fluidic barrier that prevents the brake fluid from flowing through the side wall apertures 144 into the filter 100 for being siphoned out of the brake fluid reservoir 102. The provided air may also create pressure in the filter 100 that works with the surface tension of the brake fluid F to form the fluidic barrier. The fluidic barrier may also prevent the provided air from flowing into the fluid chamber 132, thus creating a pressure imbalance between the fluid chamber and the inside of the filter 100. The result of such occurrences is that, at the end of an allotted siphoning period, the brake fluid F inside the filter 100 may be at the maximum filling level ML, while the brake fluid in the fluid chamber 132 remains above the maximum filling level. As shown in FIG. 3, the brake fluid F in the fluid chamber 132 levels with the brake fluid in the filter 100 after the siphoning, resulting in a single brake fluid level that is above the maximum filling level ML. Therefore, the prior art brake fluid reservoir 102 may be left overfilled at the end of the filling process.

### SUMMARY OF THE INVENTION

According to an aspect of the invention, alone or in combination with any other aspect, a filter for a brake fluid reservoir includes a side wall. A flange extends from the side wall at a first end of the side wall. A flange aperture extends through the flange. An end wall is at a second end of the side wall. An end aperture extends through the end wall. A first filter mesh covers the flange aperture and prevents contaminants from passing through the flange aperture. A second filter mesh covers the end aperture and prevents contaminants from passing through the end aperture.

According to another aspect, alone or in combination with any other aspect, a brake fluid reservoir for a vehicle brake system is provided. The brake fluid reservoir includes a housing that defines a fluid chamber and has a fluid inlet port. A filter is inserted into the housing. The filter is supported on an inner shoulder of the fluid inlet port via the flange.

### BRIEF DESCRIPTION OF THE DRAWINGS

The foregoing and other features of the invention will become apparent to one skilled in the art to which the invention relates upon consideration of the following description of the invention with reference to the accompanying drawings, in which:

FIGS. 1-3 are a schematic illustration of a filling process of a prior art brake fluid reservoir of a vehicle brake system;

FIG. 4 is a perspective top view of a filter for a brake fluid reservoir; and

FIGS. 5-6 are a schematic illustration of a filling process of a brake fluid reservoir of a vehicle brake system according to the present disclosure.

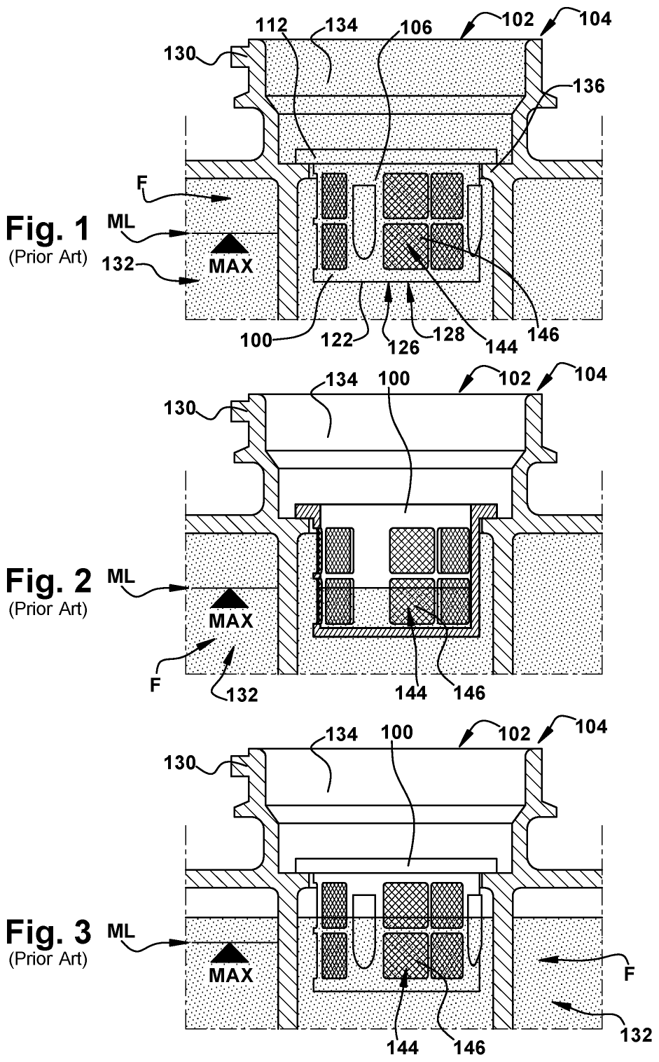

### DETAILED DESCRIPTION OF THE INVENTION

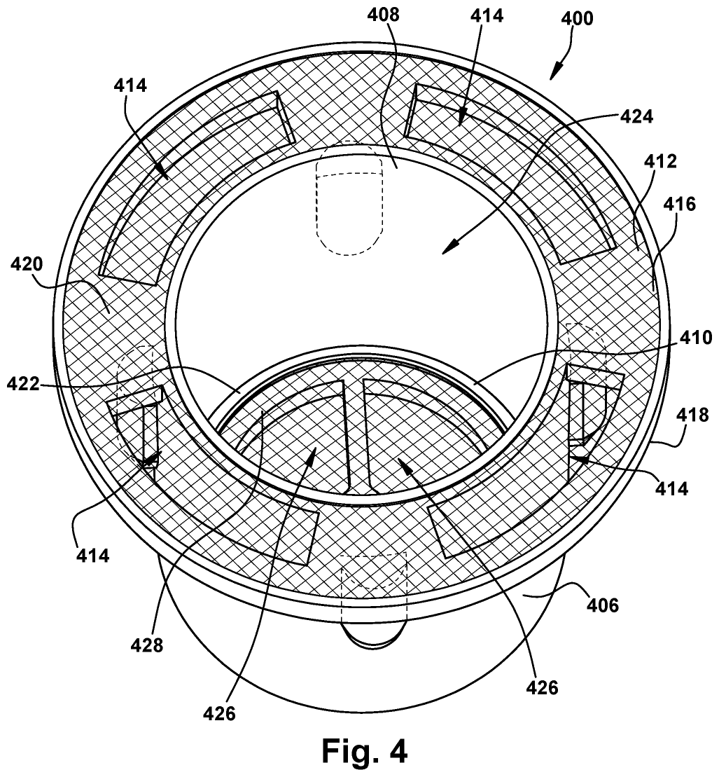

FIGS. 4-6 depict a filter 400 for a brake fluid reservoir 502 of a vehicle (e.g., a motor vehicle) brake system 504. The filter 400 includes a cylindrical side wall 406 that is free from apertures. The side wall 406 has a first end 408 and an opposite second end 410 that is spaced from the first end in a filling/siphoning direction X. A circumferential flange 412 extends radially from the first end 408. A plurality of flange apertures 414 extend in the filling/siphoning direction X through the flange 412 from a first flange surface 416 to a second flange surface 418. Although the flange 412 is shown as having four flange apertures 414 spaced evenly in a circumferential direction, the flange may have any number of flange apertures with any desired spacing.

A first filter mesh 420 is on the first flange surface 416. The first filter mesh 420 is ring-shaped and covers each of the flange apertures 414. Alternatively, the filter 400 may include a plurality of first filter meshes 420, each covering at least one of the flange apertures 414.

The second end 410 of the side wall 406 includes an end wall 422. The end wall 422 and the side wall 406 collectively define a filter chamber 424 of the filter 400. A plurality of end apertures 426 extend in the filling/siphoning direction X through the end wall 422. Although only two end apertures 426 are shown, the end wall 422 is designed having four end apertures. The end wall 422, however, may have any number of end apertures 426.

A second filter mesh 428 is on the end wall 422 inside the filter chamber 424. The second filter mesh 428 is circular-shaped and covers each of the end apertures 426. The filter 400 may, however, include a plurality of second filter meshes 428, each covering at least one of the end apertures 426.

During manufacture of the filter 400 via an injection-molding process, the first and second filter meshes 420, 428 may be placed in a mold and the remainder of the filter may be formed around the first and second filter meshes such that the flange 412 is integrally molded onto the first filter mesh and the end wall 422 is integrally molded onto the second filter mesh. The side wall 406, flange 412 and end wall 422 thus may be integrally formed in the injection-molding process, while the first and second filter meshes 420, 428 are formed prior to the formation of the remainder of the filter 400. The first and second filter meshes 420, 428 may be formed from a separate or the same material as the remainder of the filter 400. In one example, the first and second filter meshes 420, 428 may be formed from a polyamide or nylon (such as, for example, polyamide 6.6), while the side wall 406, flange 412 and end wall 422 may be formed from a polypropylene copolymer (such as, for example, a heat stabilized polypropylene copolymer). In another example, the first and second filter meshes 420, 428 may be formed from the same material as the side wall 406, flange 412 and end wall 422 and formed in a single molding process with the side wall, flange and end wall.

Although the side wall 406 is depicted as being cylindrical, the side wall may have any desired shape, with the flange 412 and/or the end wall 422 corresponding to the shape of the side wall. The first filter mesh 420, although shown as being ring-shaped, may have any desired shape and/or may be configured to correspond to the shape of the flange 412. Similarly, the second filter mesh 428, although shown as being circular-shaped, may have any desired shape and/or may be configured to correspond to the shape of the end wall 422.

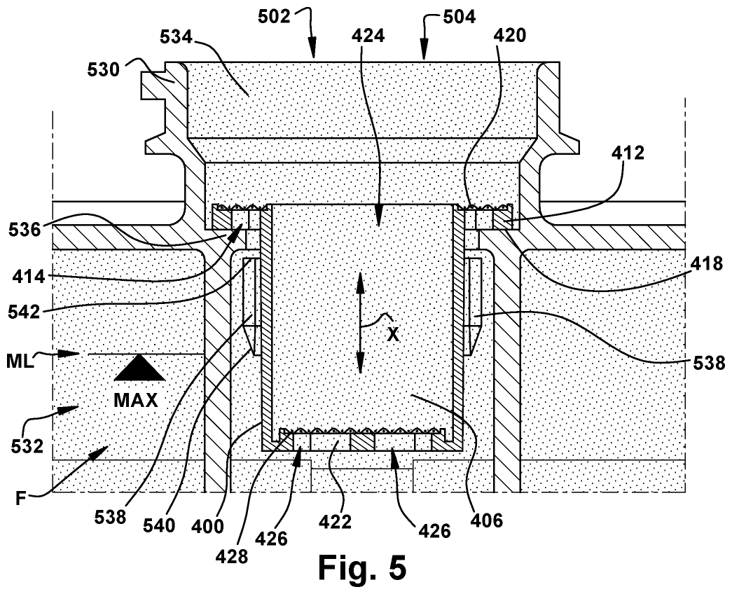

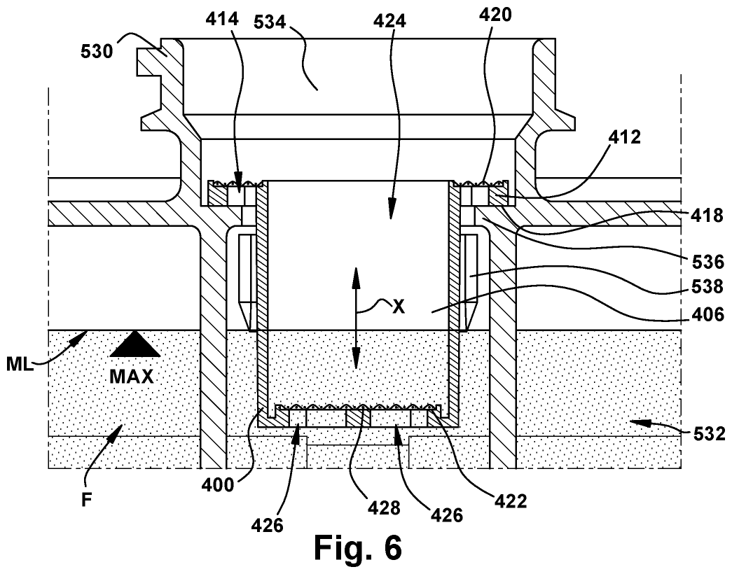

FIGS. 5-6 schematically illustrate the filter 400 inserted in the brake fluid reservoir 502. The brake fluid reservoir 502 includes a housing 530 that defines a fluid chamber 532 and has a fluid inlet port 534. The filter 400 is inserted into the fluid inlet port 534 until the second flange surface 418 engages and is supported by an inner shoulder 536 of the fluid inlet port. The side wall 406 extends from the fluid inlet port into the fluid chamber 532 such that the end wall 422 is positioned in the fluid chamber.

The side wall 406 may include at least one retaining protrusion 538 (here, a plurality of retaining protrusions) thereon for securing the filter 400 to the housing 530. Each retaining protrusion 538 has a first portion 540 formed to slantingly extend from the side wall 406 and a second portion 542 formed to perpendicularly extend from the side wall. With this retaining protrusion 538 configuration, insertion of the filter 400 into the housing 530 may be relatively easy. However, an unintended removal of the filter 400 may be substantially prevented by an engagement between the inner shoulder 536 and one or more of the second portions 542. The retaining protrusions 538 may be formed from an elastically deformable material allowing for the retaining protrusions to be deformed by the inner shoulder 536 as the filter 400 is inserted into the housing 530. Once the retaining protrusions 538 are inserted past the inner shoulder 536, they may move or “snap” back to a pre-deformed state, thus securing the filter 400 to the housing 530.

During a filling process (e.g., a vacuum filling process), a filling unit (e.g., an automatic filling unit) pours brake fluid F through the fluid inlet port 534. The brake fluid F flows primarily through the end apertures 426, but also through the flange apertures 414, into the fluid chamber 532. The brake fluid F that flows through the flange apertures 414 enters the fluid chamber 532 without passing through the filter chamber 424. The first and second filter meshes 420, 428 prevent contaminants carried by the brake fluid F from passing through the apertures 414, 426 into the fluid chamber 532 during filling.

As shown in FIG. 5, the filling unit overfills the fluid chamber 532 (i.e., fills the fluid chamber past a maximum filling level ML of the fluid chamber). As shown in FIG. 6, the excess brake fluid F is then siphoned out by the filling unit to reduce the brake fluid level in the fluid chamber 532 to the maximum filling level ML. Once the brake fluid level is siphoned to below the flange apertures 414 (which are above the maximum filling level ML), the excess brake fluid F is siphoned through only the end apertures 426 (which are below the maximum filling level) while the flange apertures provide a venting function. Air provided by the filling unit is also able to flow between the fluid inlet port 534, the filter chamber 424 and fluid chamber 532 through the flange apertures 414 for pressure-balancing.

As a result of the brake fluid F being siphoned through only the end apertures 428, and the flange apertures 414 providing venting and pressure-balancing functions, the brake fluid inside the filter chamber 424 remains substantially level with the brake fluid inside the fluid chamber 532 during siphoning. By remaining substantially level with one another, the filling unit is able to siphon the brake fluid F in the brake fluid reservoir 502 down to the maximum filling level ML during an allotted siphoning period, as is shown in FIG. 6.

From the above description of the invention, those skilled in the art will perceive improvements, changes and modifications. For example, although the filter 400 is configured to be used in the brake fluid reservoir 502 of the vehicle brake system 504, the filter make be configured for use in any other system to filter contaminants. Such improvements, changes and modifications within the skill of the art are intended to be covered by the appended claims.

Having described the invention, the following is claimed:

1. A filter for a brake fluid reservoir, the filter comprising:
a side wall;
a flange extending from the side wall at a first end of the side wall, a flange aperture extending through the flange;
an end wall at a second end of the side wall, an end aperture extending through the end wall;
a first filter mesh covering the flange aperture for preventing contaminants from passing through the flange aperture; and
a second filter mesh covering the end aperture for preventing contaminants from passing through the end aperture.

2. The filter recited in claim 1, wherein the side wall is free from apertures.

3. The filter recited in claim 1, wherein the side wall includes a retaining protrusion thereon.

4. The filter recited in claim 1, wherein the flange is spaced in a filling/siphoning direction from the end wall, the flange aperture extending in the filling/siphoning direction through the flange, the end aperture extending in the filling/siphoning direction through the end wall.

5. The filter recited in claim 1, wherein the flange has a plurality of flange apertures extending therethrough, the first filter mesh covering each of the flange apertures.

6. The filter recited in claim 1, wherein the end wall has a plurality of end apertures extending therethrough, the second filter mesh covering each of the end apertures.

7. The filter recited in claim 1, wherein the flange is integrally molded onto the first filter mesh via an injection-molding process, the end wall being integrally molded onto the second filter mesh via the injection-molding process.

8. A brake fluid reservoir for a vehicle brake system, the brake fluid reservoir comprising:
a housing defining a fluid chamber and having a fluid inlet port; and
the filter recited in claim 1 inserted into the housing, the filter being supported on an inner shoulder of the fluid inlet port via the flange;

9. The brake fluid reservoir recited in claim 8, wherein the flange is in the fluid inlet port, the side wall extending from the fluid inlet port into the fluid chamber such that the end wall is positioned in the fluid chamber.

10. The brake fluid reservoir recited in claim 8, wherein the side wall a retaining protrusion thereon for securing the filter to the housing.

11. The brake fluid reservoir recited in claim 10, wherein an engagement between the retaining protrusion and the inner shoulder prevents an unintended removal of the filter from the housing.

12. The brake fluid reservoir recited in claim 11, wherein the retaining protrusion is deformed by the inner shoulder as the filter is inserted into the housing, the retaining protrusion moving back to a pre-deformed state after moving past the inner shoulder.

13. The brake fluid reservoir recited in claim 8, wherein the side wall is free from apertures.

14. The brake fluid reservoir recited in claim 8, wherein the first and second filter meshes prevent contaminants from passing through the filter into the fluid chamber.

15. The brake fluid reservoir recited in claim 8, wherein the fluid chamber has a maximum filling level, the flange aperture being above the maximum filling level, the end aperture being below the maximum filling level.

16. The brake fluid reservoir recited in claim 8, wherein the end wall and the side wall define a filter chamber of the filter, the flange aperture permitting fluid to flow through the flange and into the fluid chamber without passing through the filter chamber.

17. The brake fluid reservoir recited in claim 16, wherein the fluid flowing through the flange aperture is at least one of brake fluid and air.

18. The brake fluid reservoir recited in claim 8, wherein the flange is integrally molded onto the first filter mesh via an injection-molding process, the end wall being integrally molded onto the second filter mesh via the injection-molding process.
